(19) United States
(12) Patent Application Publication
(10) Pub. No.: US 2012/0072233 A1
(43) Pub. Date: Mar. 22, 2012

(54) MEDICAL HEALTH INFORMATION SYSTEM FOR HEALTH ASSESSMENT, WEIGHT MANAGEMENT AND MEAL PLANNING

(76) Inventors: Alaina B. Hanlon, Waltham, MA (US); Peter Connolly, Attleboro, MA (US); Steven K. Grinspoon, Weston, MA (US)

(21) Appl. No.: 13/237,648

(22) Filed: Sep. 20, 2011

Related U.S. Application Data
(60) Provisional application No. 61/384,605, filed on Sep. 20, 2010.

(51) Int. Cl. G06Q 50/24

(52) U.S. Cl. 705/2

(57) ABSTRACT

A system and method provide nutrition assessments and tools for enabling users to achieve health-related goals based on specific health needs. The tools can include a nutrition assessment tool, a weight solution tool, a meal planning tool, and a meal tracking tool. The method includes receiving patient phenotype data. The phenotype data can include, but is not limited to, biometric data specific to the patient, medical claims data specific to the patient, organizational data specific to an organization to which the patient belongs, and behavioral data including dietary habits and nutritional history. One or more algorithms are executed on at least one processor of a computing apparatus to provide analyses of patient data in order. The results are output to a user in various web pages customized to provide features to the user.

### RELATED APPLICATION

This application claims priority to, and the benefit of, co-pending U.S. Provisional Application 61/384,605, filed Sep. 20, 2010, for all subject matter disclosed. The disclosure of said provisional application is hereby incorporated by reference herein in its entirety.

### FIELD OF THE INVENTION

The present invention relates a system and method for providing personalized medical health care information to patients or user seeking such information.

### BACKGROUND OF THE INVENTION

Conventional health and wellness management programs may include Health Risk Assessments, biometric screening, health management tools, coaching, consulting, and/or reporting. However, such programs do not offer in-depth nutritional assessment and advice. Likewise, they do not generally provide tools for improved management of achieving goals in conjunction with improving particular health needs of a patient. Conventional programs are additionally limited in customization of Health Risk Assessments and Reports.

### SUMMARY

There is a need for a health and wellness management platform provided in a computing environment that provides tools for improved management of nutritional health, including the diet and weight, of a patient. The present invention is directed toward further solutions to address this need, in addition to having other desirable characteristics.

In accordance with one example embodiment of the present invention, a computer implemented method can include receiving, from one or more input devices, patient data. The patient data can include one or more of phenotype data specific to a patient, biometric data specific to the patient, nutritional health data specific to the patient, medical claims data specific to the patient, and organizational data specific to an organization to which the patient belongs. Using one or more processors, one or more predictive models can be generated based on the patient data, and using one or more algorithms executing on at least one processor of a computing apparatus. The one or more predictive models can determine and indicate potential for development by the patient of disease and adverse health conditions, or can provide users with weight management guidelines and meal planning, or can do both. The potential for development by the patient of disease and adverse health conditions, the weight management guidelines and meal planning, or both can be output onto one or more output devices.

In accordance with further embodiments of the present invention, the potential for development by the patient of disease and adverse health conditions, the weight management guidelines and meal planning, or both further can be caused to be presented on one or more electronic displays of information. A weight solution tool can be provided. An ideal body weight for a user can be received from one or more input devices. A caloric expenditure value for the user that is based at least in part on the received patient data can be calculated using one or more processors. A first body mass index for the user that is based at least in part on the caloric expenditure value can be calculated using one or more processors. A risk percentage change that is based at least in part on the first body mass index and the received ideal body weight can be output onto one or more output devices. A basal energy expenditure for the user can be calculated using one or more processors, and the step of calculating a caloric expenditure value can be based at least in part on the calculated basal energy expenditure.

In accordance with further embodiments of the present invention, a plurality of user data pertaining to a weight goal can be received from one or more input devices. generating, using one or more processors, one or more charts or graphs including the received user data pertaining to the weight goal. The one or more generated charts or graphs can be output onto one or more output devices. The one or more generated charts or graphs can track progress of a user toward the weight goal.

In accordance with further embodiments of the present invention, a nutritional health assessment tool can be provided. Any one or more of the following can be calculated using one or more processors: a caloric intake score, a nutrient score, and a servings score. For each of a plurality of different food groups, a servings score can be calculated using one or more processors that is based at least in part on the received patient data.

In accordance with further embodiments of the present invention, a meal planner tool can be provided. One or more user preferences can be received that include one or more health needs or health goals. One or more menus presenting meal information can be output onto one or more output devices. The meal information can be customized according to the one or more health needs or health goals. A user can be enabled to modify one or more of the meal information. A calendar organizing the one or more meal information according to date can be output onto one or more output devices. A signal indicating that a user device is within a predetermined distance of a tagged location can be received from one or more input devices. Information can be sent to the user device, and the information that is sent can be determined at least in part based on the weight management guidelines, the meal planning, or both. The information further can be determined at least in part based on the tagged location.

In accordance with another example embodiment of the present invention, a computer implemented method can include receiving, from one or more input devices, patient data including one or more of phenotype data specific to a patient, biometric data specific to the patient, nutritional health data specific to the patient, medical claims data specific to the patient, and organizational data specific to an organization to which the patient belongs. One or more predictive models can be generated using one or more processors based on the patient data, and using one or more algorithms executing on at least one processor of a computing apparatus. The one or more predictive models can determine user specific weight management guidelines, meal planning recommendations, or both. The weight management guidelines, meal planning recommendations, or both can be output onto one or more output devices to the user.

In accordance with further embodiments of the present invention, the potential for development by the patient of disease and adverse health conditions, the weight management guidelines and meal planning, or both can be caused to be presented on one or more electronic displays of information. A weight solution tool can be provided. An ideal body weight for a user can be received from one or more input devices. A caloric expenditure value for the user that is based at least in part on the received patient data can be calculated using one or more processors. A first body mass index for the user that is based at least in part on the caloric expenditure value can be calculated using one or more processors. A risk percentage change that is based at least in part on the first body mass index and the received ideal body weight can be output onto one or more output devices. A basal energy expenditure for the user can be calculated using one or more processors, and the step of calculating a caloric expenditure value can be based at least in part on the calculated basal energy expenditure. A plurality of user data pertaining to a weight goal can be received from one or more input devices. One or more charts or graphs can be generated using one or more processors that include the received user data pertaining to the weight goal. The one or more generated charts or graphs can be output onto one or more output devices. The one or more generated charts or graphs can track progress of a user toward the weight goal.

In accordance with further embodiments of the present invention, a nutritional health assessment tool can be provided. Any one or more of the following can be calculated using one or more processors: a caloric intake score, a nutrient score, and a servings score. For each of a plurality of different food groups, a servings score that is based at least in part on the received patient data can be calculated.

In accordance with further embodiments of the present invention, a meal planner tool can be provided. One or more user preferences including one or more health needs or health goals can be received. One or more menus presenting meal information can be output onto one or more output devices. The meal information can be customized according to the one or more health needs or health goals. A user can be enabled to modify one or more of the meal information. A calendar organizing the one or more meal information according to date can be output onto one or more output devices.

In accordance with yet further embodiments of the present invention, a signal indicating that a user device is within a predetermined distance of a tagged location can be received from one or more input devices. Information can be sent to the user device, and the information that is sent can be determined at least in part based on the weight management guidelines, the meal planning, or both. The information further can be determined at least in part based on the tagged location.

In accordance with another example embodiment of the present invention, in a networked computer environment, a system can include a storage device storing patient data including one or more of phenotype data specific to a patient, biometric data specific to the patient, nutritional health data specific to the patient, medical claims data specific to the patient, and organizational data specific to an organization to which the patient belongs. At least one processor can be included that is provided with executable instructions for generating one or more predictive models, using one or more algorithms executing on the at least one processor, and the one or more predictive models can determine and indicate a potential for development by the patient of disease and adverse health conditions, or cam provide users with weight management guidelines and meal planning, or can do both. An output mechanism can be included that is configured to output the potential for development by the patient of disease and adverse health conditions, the weight management guidelines and meal planning, or both.

In accordance with yet another example embodiment of the present invention, in a networked computer environment, a system can include a storage device storing patient data including one or more of phenotype data specific to a patient, biometric data specific to the patient, nutritional health data specific to the patient, medical claims data specific to the patient, and organizational data specific to an organization to which the patient belongs. One or more predictive models can be generated based on the patient data, and using one or more algorithms executing on at least one processor of a computing apparatus. The one or more predictive models can determine user specific weight management guidelines, meal planning recommendations, or both. An output mechanism can be included that is configured to output the weight management guidelines, meal planning recommendations, or both, to the user.

### BRIEF DESCRIPTION OF THE DRAWINGS

The present invention will become better understood with reference to the following description and accompanying drawings, wherein:

FIG. 1 is a schematic illustration of a representative networked computer environment in which a system for providing personalized medical health information to users can be implemented;

FIG. 2 is a schematic illustration depicting an example computing environment suitable for practicing exemplary embodiments of the present invention;

FIG. 3 is a homepage starting screen that can display systems directing the illustrative embodiment to users on their client devices;

FIG. 4 is a screen shot of a sample nutrition summary web page containing a nutritional score;

FIG. 5 is a screen shot of a second sample nutrition summary web page showing serving size and caloric intake for various food groups;

FIG. 6 is a screen shot of a third sample nutrition summary page providing informational text on nutrition and a more detailed write up of the analysis based on division of food groups;

FIG. 7 is a screen shot of a sample user data input screen for collecting information from a user;

FIG. 8 is a screen shot of a web page for receiving information from a user such as target amount of weight loss/gain, as well as other information;

FIG. 9 is a screen shot of a weight goal summary page;

FIG. 10 is a screen shot of a progress summary page for tracking weight loss/gain/maintaining of a user;

FIG. 11 is screen shot of a web page for presenting a target date for reaching a user's goal to lose, gain, or maintain weight;

FIG. 12 is a screen shot of a “Today's Menu” page for planning meals;

FIG. 13 is a screen shot of s a pop-up screen for allowing a user to build a menu from suggested meals; and

FIG. 14 is a screen shot of a “Today's Menu” page for building a menu without suggested meals.

### DETAILED DESCRIPTION

The illustrative embodiment medical health system and method of the present invention as described herein provides a fully integrated health management and productivity solution built on the science of phenotyping, behavioral habits, and desired patient goals based on specific or general health needs. A genotype is conventionally defined as a trait or set of traits of an individual as dictated and determined by their genetic makeup. A phenotype is conventionally defined as the appearance, or expression of a trait, of an individual, resulting from the interaction of the genotype with the particular environment of the individual. Phenotyping is a methodology that looks at the environmental interactions, including lifestyle, behaviors, and environment, also considering genetics, to assess an individual's current and future health. The system and method of the present invention provide a platform that enable such activities as health risk and productivity assessments, biometric screening—including at home screening, customizable reports, coaching, education, tools that help drive engagement and compliance such as multi-channel communications and incentives, and consulting services to help define, implement, and manage health and wellness initiatives. The system and method provide nutritional consulting and assessment and also provide features and services that can assist users with weight management and meal planning.

The illustrative embodiment of the present invention can provide patients (perhaps with a registration prerequisite) with access to pharmaceutical, medical, nutritional, and dietary information that is specific to their health needs as well as their personal health goals by logging into a customized online health management portal.

The illustrative embodiment of the present invention can enable pharmaceutical and other medical companies to more efficiently and effectively target advertising to consumers. Pharmaceutical and other medical companies can pay to advertise relevant drugs, treatments, etc. to targeted patients. The advertisements may be targeted to people with particular phenotypes and/or genotypes and/or behavioral habits. For example, people with a high risk of heart disease can be provided with advertisements and have access to health information for cholesterol lowering drugs, hypertension, etc. The pharmaceutical companies and other advertisers preferably will not have direct access to the patients or their medical information. All medical information stored on the site can be de-identified to protect the privacy of patients.

The illustrative embodiment can also provide a social network that allows users to connect with other patients of a particular phenotype and/or genotype.

It should be noted that the term “user” and the term “patient” are used somewhat interchangeably herein. The system and the method of the present invention can be operated or practiced by a user of the system and method. That user may also be a patient, and may specifically be the patient from whom the health and medical information is obtained, and for whom the output of the system is generated. However, a patient may delegate actual interaction with the system and method to a user that is acting on behalf of the patient. As such, the information relating to health may be specific to the patient, but login information may be specific to a user. Likewise, a user that is also the patient may operate or practice the system and method of the present invention, or a user that is not also the patient may operate or practice the system and method of the present invention, as would be understood by those of ordinary skill in the art.

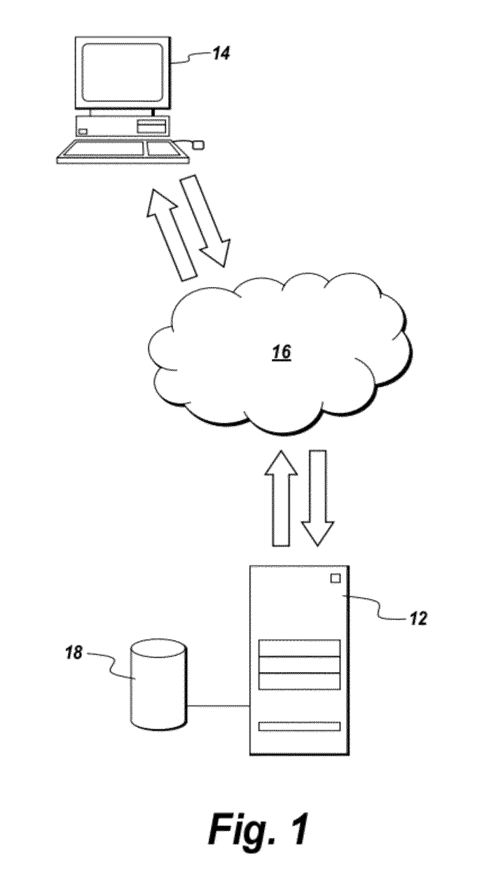

FIG. 1 schematically illustrates a representative networked computer environment in which a system for providing personalized medical health information to users can be implemented. In general, the system includes a server system 12 for delivering content to a plurality of user terminals or client devices 14 operated by users over a network 16. Each user client device 14 has an associated display device for displaying the delivered content. Each client device 14 also has one or more user input devices that enable the user to interact with a user interface on the client device 14. Input devices can include, but are not limited to touch screens, keyboards, and mice or other pointer devices.

The network 16 can take the form of a computer network such as, e.g., the Internet (particularly the World Wide Web), Intranets, or other networks. Communication to, from, and through the network 16 can occur through a hardwire connection, a network connection, or a wireless connection, including a cellular or WiFi connection, and as such further includes at least one internal antenna and/or input/output jack (not shown). The server system 12 can comprise, e.g., a Web server. The client device 14 can comprise, e.g., a personal computer or a portable communication device such as a personal digital assistant (PDA) or a cellular telephone. The client device 14 can include a browser, which may, e.g., be any of a variety of conventional web browsers.

The server system 12 includes access to one or more databases or electronic storage systems 18, which can be used to store information on system users, including patient phenotype and/or genotype information, as well as the content (including information on medical health topics and advertisements) to be delivered to client devices operated by the users.

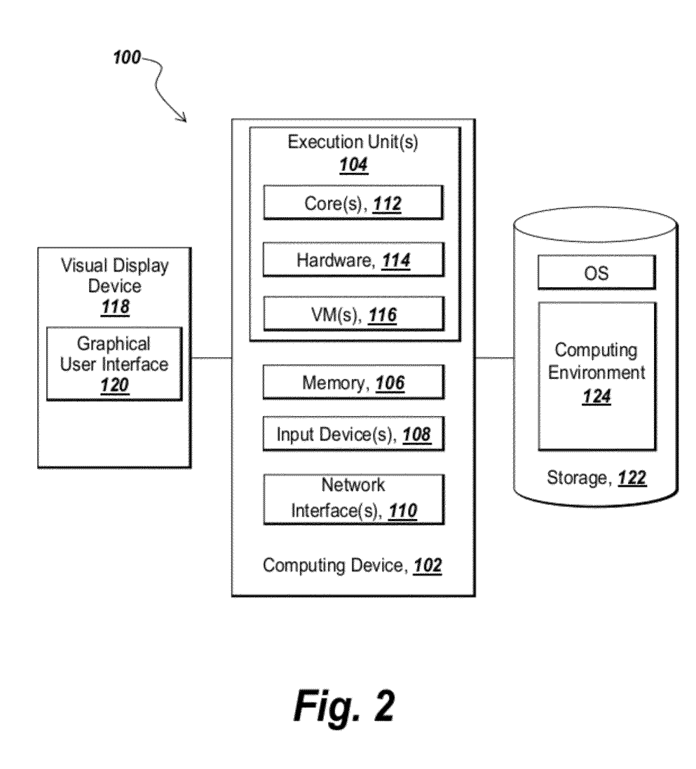

As described herein, the system and method of the present invention are implemented in a computer networked environment. Each computing component involved in the computer networked environment, including the client device 14 and the server system 12, can each take the form of its own computing environment 100. FIG. 2 depicts an example computing environment 100 suitable for practicing exemplary embodiments of the present invention. As indicated herein, the present system and method can be implemented on one or more computing devices 102. The computing environment 100 includes the computing device 102, which may include execution units 104, memory 106, input device(s) 108, and network interface(s) 110. The execution units 104 may include hardware or software based logic to execute instructions on behalf of the computing device 102. For example, depending on specific implementation requirements, execution units 104 may include: one or more processors, such as a microprocessor; single or multiple cores 112 for executing software stored in the memory 106, or other programs for controlling the computing device 102; hardware 114, such as a digital signal processor (DSP), a graphics processing unit (GPU), a field programmable gate array (FPGA), an application specific integrated circuit (ASIC), etc., on which at least a part of applications can be executed; and/or a virtual machine (VM) 116 for executing the code loaded in the memory 106 (multiple VMs 116 may be resident on a single execution unit 104).

Depending on specific implementation requirements, the memory 106 may include a computer system memory or random access memory (RAM), such as dynamic RAM (DRAM), static RAM (SRAM), extended data out RAM (EDO RAM), etc. The memory 106 may include other types of memory as well, or combinations thereof. A user may interact with the computing device 102 through a visual display device 118, such as a computer monitor, which may include a graphical user interface (GUI) 120. The computing device 102 may include other I/O devices, such as a keyboard, and a pointing device (for example, a mouse) for receiving input from a user. Optionally, the keyboard and the pointing device may be connected to the visual display device 118. The computing device 102 may include other suitable conventional I/O peripherals. Moreover, depending on particular implementation requirements of the present invention, the computing device 102 may be any computer system such as a workstation, desktop computer, server, laptop, handheld computer or other appropriate form of computing or telecommunications device that is capable of communication and that has sufficient processor power and memory capacity to perform the operations described herein.

Additionally, the computing device 102 may include interfaces, such as the network interface 110, to interface to a Local Area Network (LAN), Wide Area Network (WAN), a cellular network, the Internet, or another network, through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), synchronous transfer mode (STM), wireless connections (e.g., 802.11), high-speed interconnects (e.g., InfiniBand, gigabit Ethernet, Myrinet) or some combination of any or all of the above as appropriate for a particular embodiment of the present invention. The network interface 110 may include a built-in network adapter, network interface card, personal computer memory card international association (PCMCIA) network card, card bus network adapter, wireless network adapter, universal serial bus (USB) network adapter, modem or any other device suitable for interfacing the computing device 102 to any type of network capable of communication and performing the operations described herein.

The computing device 102 may further include a storage device 122, such as a hard-drive, flash-drive, or CD-ROM, for storing an operating system (OS) and for storing application software programs, such as the computing application or environment 124. The computing environment 124 may run on any operating system such as any of the versions of the conventional operating systems, any embedded operating system, any real-time operating system, any open source operating system, any proprietary operating system, any operating systems for mobile computing devices, or any other operating system capable of running on the computing device and performing the operations described herein. Furthermore, the operating system and the computing environment 124 may in some instances be run from a bootable CD.

One of ordinary skill in the art will appreciate that the above description concerning the computing environment 100 and computing device 102 is intended to encompass all conventional computing systems suitable for carrying out methods of the present invention. As such, any variations or equivalents thereof that are likewise suitable for carrying out the methods of the present invention are likewise intended to be included in the computing environment 100 described herein. Furthermore, to the extent there are any specific embodiments or variations on the computing environment 100 that are not suitable for, or would make inoperable, the implementation of the present invention, such embodiments or variations are not intended for use with the present invention.

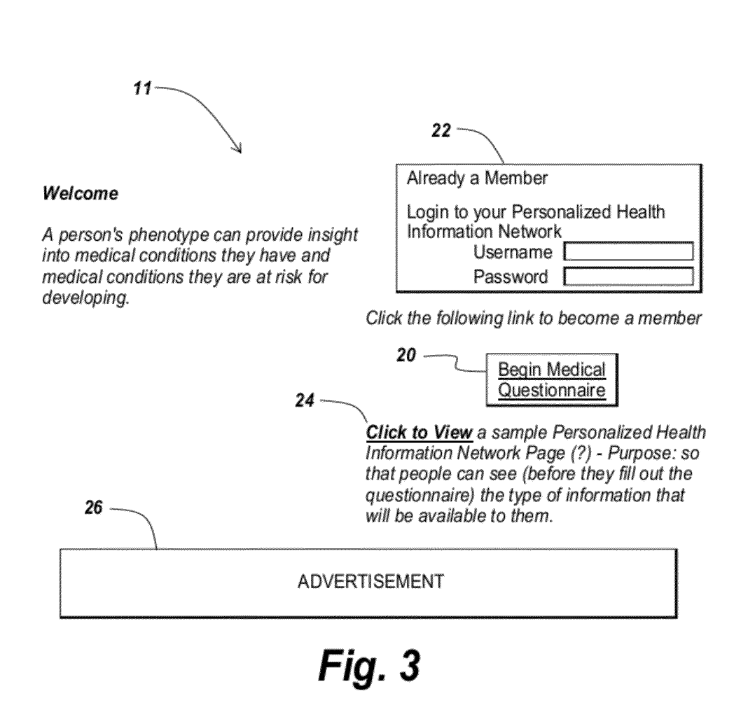

FIG. 3 illustrates a homepage starting screen 11, as would be understood by those of ordinary skill in the art, which can display to users the system of the present invention on their client devices 14. If the user is a new user, he or she can select a link to establish an account with the system and fill in a medical questionnaire to develop a phenotype. Existing users of the system can log in by entering unique user identification information, e.g., a username and password in a login block 22.

The user can also select a link 24 to view a sample personalized health management portal so that he or she can obtain a better understanding of the type of information that will be available if he or she registers to use the service.

To become a member (i.e., a registered user), a new user can be asked to enter information for creating a login, beginning by clicking on a new member link 20. Users are preferably not asked to provide personal identification information. The user can be requested to enter the following: email address, username, password, security question, type in a word appearing in a box (to restrict access to the system by automated programs), agreed to acceptance of terms & conditions. Thereafter, the user is routed to the beginning of a medical questionnaire.

The system can include multiple tiers of advertisements, depending on the particular webpage accessed by the user. For example, Tier (I) advertisements can be provided on the site Homepage in an advertising block 26, where the highest traffic can be expected.

Tier (II) advertising can be provided on the homepage of a user's personalized health management portal, or other subsequent pages within the system. This page has the highest traffic for each “username,” i.e., each registered user can be expected to access this page more frequently than any other page on the site.

Tier (III) advertising can be provided on the pages addressing specific medical conditions within a user's personalized health management portal. This page can be expected to have the highest traffic for each “username” with the specific “condition.”

Tier (III+) advertising can comprise additional tiers of advertising for further sub pages accessed by users.

To encourage return user traffic to the system, when new medical information becomes available for a user or patient, his or her personalized health management portal can be automatically updated, a user can be sent an email (or otherwise be notified) informing him or her that new medical information is available. A link to the system website can be included in the email for convenience.

After a user completes one or more questionnaires, he or she can log into their personalized health management portal Homepage using their Username and Password. Information entered by the user in the questionnaire is used to determine the patient's phenotype. Based on that phenotype, personalized health information can be provided to the user. More specifically, the health management portal tool of the present invention takes all of the information provided concerning a patient and implements a process wherein a number of analyses and operations are conducted to result in an overall nutritional assessment. The illustrative embodiment transforms the information concerning the patient into the output discussed herein. The methodology involves generating a prognostic model. The prognostic model or models make use of a one or more algorithms executing on at least one processor of a computing apparatus. The prognostic model or models determine and indicate or communicate a range of assessments to the user regarding the patient's nutritional health status according to the model.

Methods for implementing the illustrative embodiment are disclosed herein. The data is first provided to the system. The data can include phenotype data specific to a patient, nutritional health data specific to the patient, biometric data specific to the patient, medical claims data specific to the patient, and organizational data specific to an organization to which the patient belongs. Phenotype data can include data fields comprising height, weight, waist circumference, biometric data, smoking frequency, alcohol consumption, lifestyle data, emotional data, behavioral data, and the like. Nutritional data can include dietary habits, frequency of consumption, food groups included in meals, average amounts of exercise, etc. Biometric data can include data fields comprising total cholesterol, HDL cholesterol, LDL cholesterol, triglycerides, fasting glucose, hemoglobin A1c, ALT liver enzyme, C-Reactive Protein, Complete Blood Count, and the like. Medical claims data can include data fields comprising health insurance claims for medical procedures, prescription medication cost, doctor visit fees, and the like. Organizational data can include data fields comprising current health by condition, health risks by condition, productivity, absenteeism, lost time, predictive modeling, medical claims analysis, program eligibility, program participation, direct medical cost analysis, indirect medical cost analysis, return on investment, and the like. One of ordinary skill in the art will appreciate that the above data fields are all illustrative of what may be utilized in a health risk predictive model. Accordingly, the present invention is by no means limited to the precise data fields provided herein, which are provided merely for illustrative purposes.

In the illustrative embodiments, patients provide detailed information about their nutritional health, general health, and health-related goals and preferred ways of achieving those goals, such as through completion of questionnaires, from which their nutritional health and goals can be determined. The questionnaires can include a nutritional questionnaire containing questions on a patient's basic physiological measurements (height, weight, waist circumference, etc.), questions on the patient's dietary habits and history, and questions on the patient's medical history including medications used, illnesses, etc. The dietary questionnaire can be an online form that can be similar to forms for collecting information in conventional medical analyses tools. Additional questionnaires regarding meal preferences, weight loss/gain/maintaining goals, and specific health needs can be provided to a user.

The questionnaires, as well as other data collection web pages, can be utilized and presented to the user as various tool packages that provide related features for determining health and assisting users in achieving their goals. The tool packages can include a nutritional health assessment tool, a weight solution tool, and a meal planner tool. The information, recommendations, assessments, proposed weight solutions, generated meal plans, and other data created by the system and presented on an output device (e.g., as a display) can be based at least in part on one or more predictive models. For example, the one or more predictive models can include any of the one or more predictive models described in detail in co-pending, U.S. application Ser. No. 12/727,728, entitled “Medical Health Information System,” the entire contents of which are hereby incorporated by reference. Likewise, other predictive models may be utilized in conjunction with the present invention, as would be appreciated by those of skill in the art. Furthermore, these various tools described herein can be utilized together as a collaborative effort and can be used independently of one another. The illustrative embodiment described below provides a particular implementation that does not limit the scope of the invention.

### Nutritional Health Assessment Tool

The illustrative embodiment of the present invention includes a nutritional health assessment tool for determining and analyzing the specific health of a patient to provide them with information to improve their health through dietary lifestyle changes. The dietary questionnaire can include some or all of the questions listed and categorized below, but the present invention is by no means limited to the particular questions described herein, as would be understood by those of ordinary skill in the art.

### Discretionary Calories Questions:

1.) How often do you add salt to your food?
2.) How often do you eat at fast food type restaurants—pizza, burgers, subs, doughnuts, fries?
3.) How often do you have salty snacks such as regular potato chips, corn chips, packaged popcorn, crackers?
4.) How often do you have prepared, packaged or canned foods
5.) How often do you add whole milk or cream to coffee or tea?
6.) How often do you add butter to foods such as bread, potatoes, etc?
7.) How often do you have sweet foods such as cake, cookies, pie, chocolate candy and ice cream?
8.) How often do you have sweetened beverages such as regular soft drinks, sweetened teas and juices?
9.) How often do you add sugar or honey to coffee, tea, or cereal?
10.) How often do you have specialty coffee drinks such as coolattas, lattes, etc?

### Vitamin and Mineral Supplements Questions:

Do you take daily multiple vitamins?
Do you take Calcium and/or Vitamin D supplements?

### Fluid Questions:

How many glasses of water do you drink per day?

### Dairy Questions:

1) How often do you have low fat or fat free milk including soy, low fat or fat free cheese including soy, or low fat yogurt?
Optional follow-up: What is your serving size? (Serving size=1 cup milk or yogurt, 1.5 ounce of cheese, ⅓ cup shredded)
2) How often do you have whole milk, regular cheese or whole milk yogurt?
Optional follow-up: What is your serving size? (Serving size=1 cup milk or yogurt, 1.5 ounce of cheese, ⅓ cup shredded)

### Fruit Questions:

3) How often do you have fresh, frozen, dried or canned (in own juice) fruit?
Optional follow-up: What is your serving size? (Serving size=½ cup of fruit or juice, ¼ cup dried, 1 medium piece)
4) How often do you have 100% fruit juice?
Optional follow-up: Is the juice calcium fortified?
Optional follow-up: What is your serving size? (Serving size=½ cup of fruit or juice, ¼ cup dried, 1 medium piece)

### Vegetables:

5) How often do you have 100% vegetable juice, dark green or orange vegetables such as broccoli, carrots, tomato, leafy greens, and squash?
Optional follow-up: What is your serving size? (Serving size=½ cup of raw or cooked vegetables or juice, 1 cup of leafy greens)
6) How often do you have starchy vegetables such as corn, peas, lima beans and or/potatoes?
Optional follow-up: What is your serving size? (Serving size=½ cup cooked vegetables)

### Bread and Cereal Questions:

7) How often do you have high fiber cereal, bread or whole grain products such as whole wheat, whole oats, whole rye, barley, wild rice, buckwheat, bulgur, millet or quinoa?
Optional follow-up: What is your serving size? (Serving size=1 slice of bread, 1 cup of ready to eat cereal, ½ cup of cooked rice, cooked pasta or cooked cereal/grain)
8) How often do you have white rice, pasta, bread or toast including French, Italian, rolls, buns, bagels or in sandwiches?
Optional follow-up: What is your serving size? (Serving size=1 slice of bread, 1 cup of ready to eat cereal, ½ cup of cooked rice, cooked pasta or cooked cereal)

### Meats/Poultry/Fish Questions:

9) How often do you have lean protein such as white meat chicken or turkey no skin, pork or beef with visible fat trimmed?
Optional follow-up: What is your serving size? (Serving size=3-4 ounce meat or poultry)
10) How often do you have fish or seafood?
Optional follow-up: What is your serving size? (Serving size=3-4 ounce fish or seafood)
11) How often do you consume processed or deli meats, such as roast beef, corned beef, ham, salami, pastrami?
Optional follow-up: What is your serving size? (Serving size=3 slices or 3 ounces)
12) How often do you have eggs?
Optional follow-up: What is your serving size? (Serving size=2 eggs)

### Dried Beans/Nuts and Seeds:

13) How often do you have dried beans such as kidney, black beans, soy beans, tofu, chick peas, etc?
Optional follow-up: What is your serving size? (Serving size=½ cup cooked dry beans, or tofu, 2 Tb hummus)
14) How often do you have nuts and seeds such as almonds, walnuts, cashew nuts, peanuts or peanut butter?
Optional follow-up: What is your serving size? (Serving size=½ ounce of nuts or seeds, 1 Tb peanut butter)

### Fat/Oil Questions:

15) How often do you use oils such as olive, sunflower, safflower, canola, or corn either in salad dressing, or in cooking?
Optional follow-up: What is your serving size? (Serving size=1 tsp oil, 2 Tb light dressing)
16) How often do you use soft margarine with zero trans fat?
Optional follow-up: What is your serving size? (Serving size=1 tsp)

Possible answers to the above yes or no questions include “yes” and “no.” Possible answers to the above quantitative questions can include:

Never

Once per month

2-3 per month

Once per week

2-4 per week

5-6 per week

Once per day

2 per day

3 per day

4-5 per day

6+ per day

For users who select answers other than “never,” optional answers to the above follow-up questions about serving sizes can include, e.g., “about 1 serving,” “smaller than 1 serving,” and “larger than 1 serving.”

For instance, as would be appreciated by one of skill in the art, all such questions and answer choices described above and in further detail herein can be presented to the users on an output device. In illustrative embodiments, the surveys described herein are presented as a display on a monitor of a computing device (e.g., which includes a non-transitory computer readable storage device) connected by a communications network to the inventive computing system.

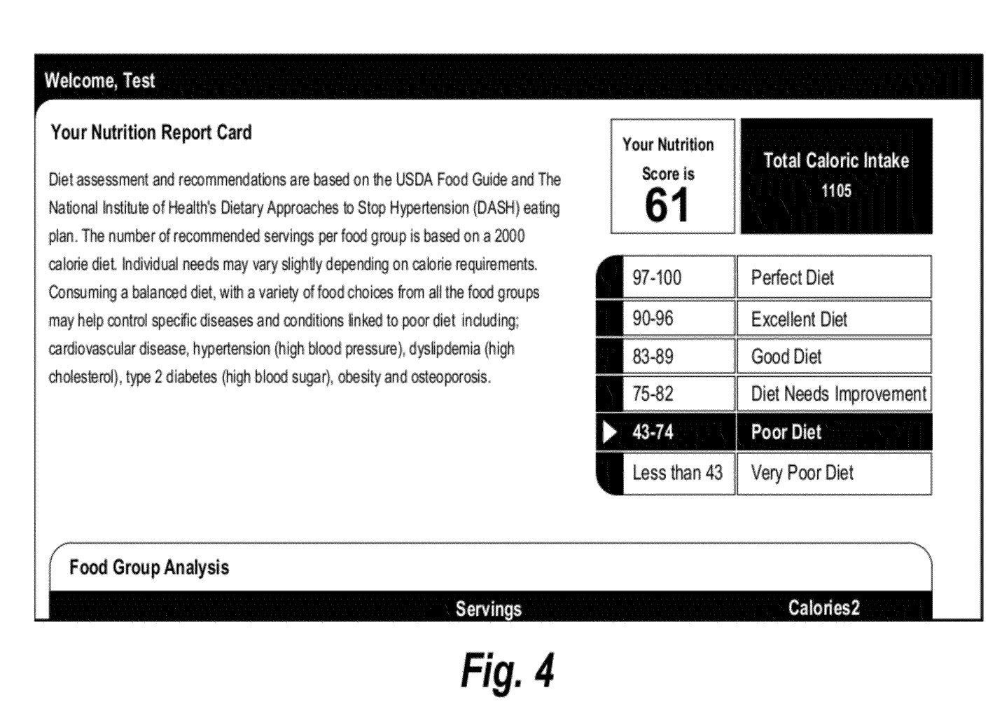

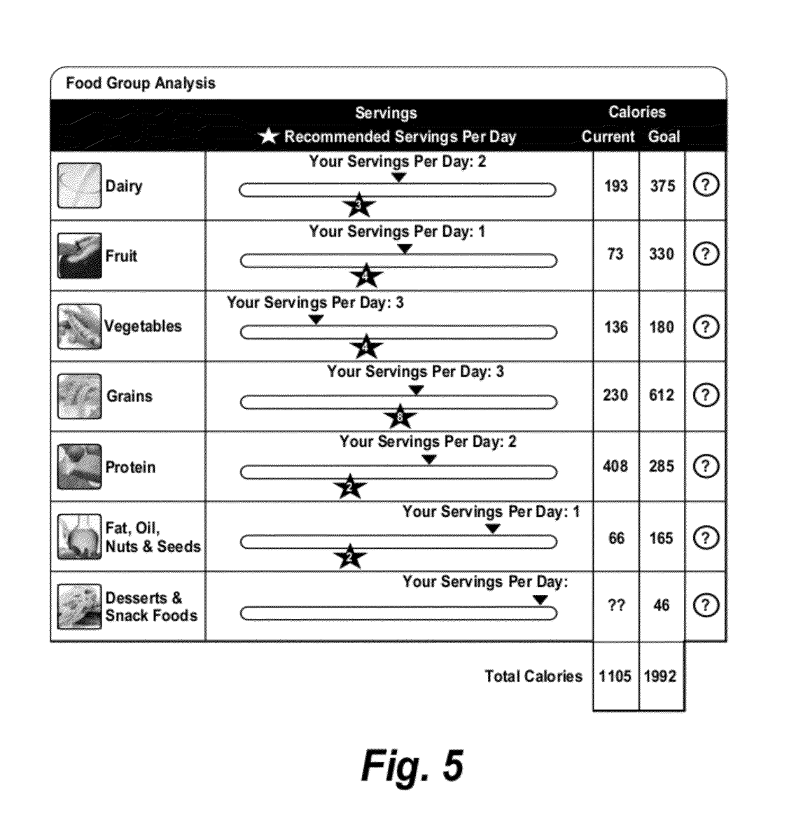

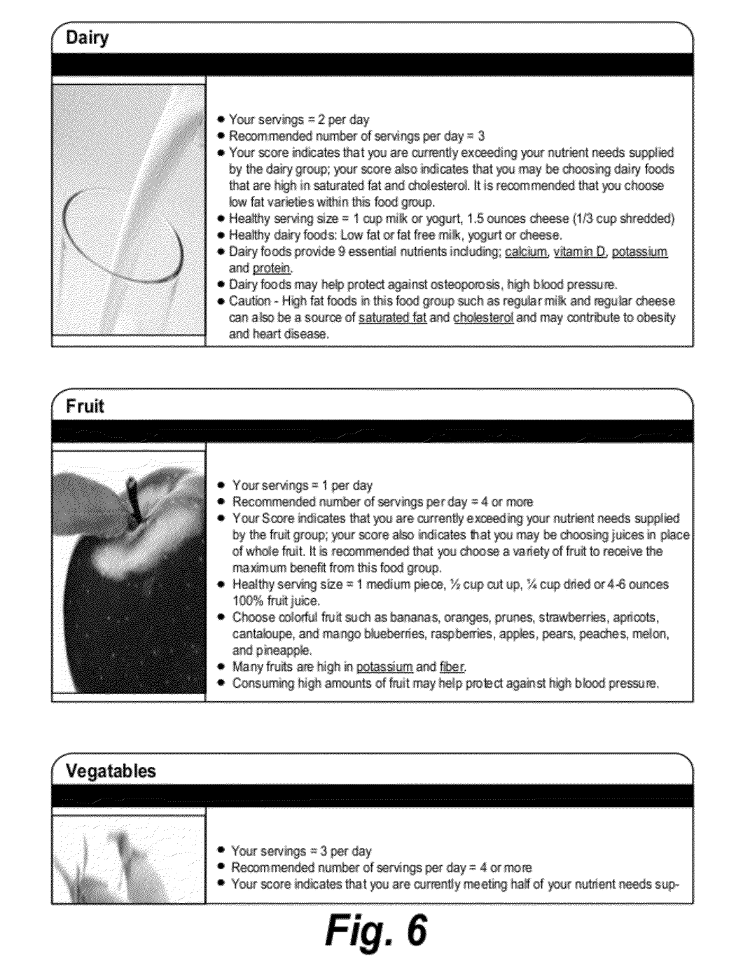

In the illustrative embodiment of the present invention, nutritional data supplied by the user is analyzed using various algorithms to perform an overall nutritional health assessment of the patient. The nutritional health assessment tool manipulates the data to output a nutrition score (based on a 100-point scale), an estimated and recommended value of total caloric intake, an estimated and recommended number of servings per food group along, and estimated and recommended value of caloric intake per food group, etc. For example, the information and assessment can be based on one or more of the predictive models already described or incorporated by reference herein. This information, along with other informative text and recommendations, is included in one or more nutrition summary pages that are presented to the user. FIG. 4 shows an example nutrition summary page containing a nutritional score. FIG. 5 shows a second example nutrition summary page showing serving size and caloric intake for various food groups. FIG. 6 is a third example nutrition summary page providing informational text on nutrition and a more detailed write up of the analysis based on division of food groups.

Various algorithms and analyses tools can be used to calculate the patient's overall nutrition score, as well as the actual and recommended values described above. As described above, the predictive models described or incorporated by reference herein can be used for such calculation. In the illustrative embodiment of the present invention, three different nutritional scores are calculated and then used to determine the information provided in the summary page. The three nutritional scores are number of servings, calories, and nutrient score, and they are each calculated using some or all of the answers provided by the user.

### Number of Servings

### Discretionary Calories Servings

In the illustrative embodiment, each of the answers to the frequency of discretionary servings will have a corresponding number of servings assumed. These are given below.

Never=0 servings per day

Once per month=0 servings per day

2-3 per month=0 servings per day

Once per week=0 servings per day

2-4 per week=3 servings per week=3/7 servings per day=0.43 per day

5-6 per week=5.5 servings per week=5.5/7 servings per day=0.79 per day

Once per day=1 serving per day

2 per day=2 servings per day

3 per day=3 servings per day

4-5 per day=4.5 per day=2 servings per day

Etc.

### Non-Discretionary Servings

As described herein, the illustrative embodiment gathers patient data such as the frequency of servings of consumption for nearly all food groups, as well as water intake. For any frequency less than or equal to once per week, the estimated servings is zero. For the remaining frequencies, if a frequency range is selected, the average of the answered range is used. If the frequency range is for a period of greater than a week, then it is converted to daily intake using an appropriate conversion factor. For example, weeks are converted to days by dividing by 7. Specifically, some example possible answers and their corresponding daily frequencies are:

Never=0 servings per day

Once per month=0 servings per day

2-3 per month=0 servings per day

Once per week=0 servings per day

2-4 per week=3 servings per week=3/7 servings per day=0.43 per day

5-6 per week=5.5 servings per week=5.5/7 servings per day=0.79 per day

Once per day=1 serving per day

2 per day=2 servings per day

3 per day=3 servings per day

4-5 per day=4.5 per day=2 servings per day

Etc.

Next, the frequency is adjusted by the serving size for every food group. This operation is not performed for the frequency value of water consumed. If the user indicates that the serving size is “About 1 serving,” then no conversion is performed (i.e., multiplication by 1). For serving sizes of “Larger than 1 serving,” the frequency value is multiplied by 1.5 to give the proper number of servings per day, unless the food group is grains. For grains, if the portion size is “Larger than 1 serving,” then the frequency is multiplied by 2. This is because on average, people eat either 1 slice of bread or 2 slices of bread, and not 1.5 slices. Therefore, “Larger than 1 serving” most likely indicates a value of 2 servings. If the user states that their serving size is “Smaller than 1 serving,” then the frequency is multiplied by 0.5 to get the servings per day.

After calculating the servings per day for each question, the servings per day can be summed up across all questions in a food group. For example, if the user indicates that they consume 2-4 servings per week of low-fat dairy and his serving size is “Larger than 1 serving,” the number of servings of low-fat dairy is:

(3/7)*1.5=0.643 servings

If the same user also indicates that he consumes 5-6 servings per week of high-fat dairy with serving sizes of “About 1 serving,” then their high-fat dairy servings are calculated as:

(5.5/7)*1=0.786 servings

Therefore, the user's total servings/day of dairy is:

0.643+0.786−1.429

For the user, calculations of calories and nutrient score are based on this number (with the exception that the value used for calculations will be as precise as possible and thus will include additional decimal places of accuracy). When the servings per day for a food group is displayed directly to the user, the value will be rounded to the nearest tenth (i.e., in the example above, 1.4). One of skill in the art will appreciate that these calculations, values, and weightings are intended as illustrative and non-limiting. Other embodiments of the present invention utilize a wide variety of other calculations, values, weights, and the like.

### Calories

In the illustrative embodiment, a number of estimated calories per serving is given by Table I below. The values in this table are multiplied by the adjusted number of servings per day to give the number of calories per day for the patient.

TABLE 1
Calorie Conversion Chart

| Question | Calories per serving |
|---|---|
| Discretionary Question #1 | 0 |
| Discretionary Question #2 | 456 |
| Discretionary Question #3 | 159 |
| Discretionary Question #4 | 282 |
| Discretionary Question #5 | 90 |
| Discretionary Question #6 | 135 |
| Discretionary Question #7 | 211 |
| Discretionary Question #8 | 208 |
| Discretionary Question #9 | 20 |
| Discretionary Question #10 | 324 |
| Dairy Low Fat | 125 |
| Dairy High Fat | 152 |
| Fruit Whole | 60 |
| Fruit Juice | 60 |
| Vegetables | 28 |
| Vegetables - starch | 72 |
| Grains - Whole | 76.5 |
| Grains - other | 76.5 |
| Lean Meat | 165 |
| Fish | 165 |
| Deli | 219 |
| Eggs | 73 |
| Beans | 32.5 |
| Nuts and seeds | 100 |
| Oils Healthy | 45 |
| Oils soft marg | 45 |
| Fluids | 0 |

Continuing with the example from above, the number of low fat dairy calories per day is: 0.643 servings*125 calories/serving=80.3 calories. Similarly, for high fat dairy calories, the value is: 0.786 servings*152 calories/serving=119.5 calories. Finally, the value of total dairy food group calories is: 80.3+119.5=199.8 calories

### Nutrient Score

### Discretionary Score

In the illustrative embodiment, for each discretionary question, 3 points is added to a patient discretionary score for each answer of “Less than once per month” or “Monthly.” Any other answers count as 0 points toward the patient discretionary score.

### Non-Discretionary Score

Each food group and water has a recommended number of daily servings, which are given by TABLE 2:

TABLE 2
Recommended Servings Per Food Group

| Food Group | Recommended # of Servings |
|---|---|
| Dairy | 3 |
| Fruit | 4.5 |
| Vegetable | 4.5 |
| Grains | 7 |
| Protein | 2 |
| Fat, Oil, Nuts and Seeds | 2 |
| Water | 6 |

The recommended numbers from TABLE 2 correspond with the recommended values shown on the nutrition summary page of FIG. 5. The values in this table can change according to new research and studies, and can be changed according to the particular health needs or goals of the patient.

Calculations of the nutrient score are given by first summing the adjusted number of servings across all questions in the food group. The food group nutrient score is then given by the equation:

Food group nutrient score=10*(Total number of servings)/(Recommended Number of servings)

Nutrient scores greater than 10 are capped at 10. To determine the patient's total nutrient score, each of the scores for the food groups (out of 60 points) and water (out of 10 points) is added with the score for each discretionary question (out of 30 points). The total points possible is therefore 100 points.

To continue with the working example from above, the total dairy servings can be calculated as: 0.643 servings+0.786 servings=1.429 dairy servings. The dairy nutrient score is therefore: Dairy nutrient score=(1.429 servings/3 servings)*10=4.76 points.

If, the other hand, the patient consumed a combined total of 6 servings of dairy, then the points would be calculated as:

Dairy nutrient score=(6 servings/3 servings)*10=20 points.

However, since a maximum of 10 points can be given for dairy, the patient's dairy nutrient score is 10.

### Conditional Text:

Various text can be included for each food group, as shown in FIG. 6. In the illustrative embodiment, this text includes a combination of static text and dynamic text. The dynamic text should follow the rules described below, in accordance with one example illustrative embodiment of the present invention.

### Dairy

For questions 1 and 2, a combined score of 3 (3 servings per day) indicates nutrient needs are met for this food group. In this and similar scenarios, the text can begin with the phrase, “Congratulations, your score indicates that you are currently meeting your nutrient needs supplied by the dairy group.” A combined score of greater than 3 (>3 servings per day) indicates that nutrient needs are being exceeded for this food group. In this and similar scenarios, the text can begin with the phrase, “Your score indicates that you are currently exceeding your nutrient needs supplied by the dairy group. It is recommended that you decrease your intake of dairy foods to 3 servings per day.” A combined score of less than 3 (<3 servings per day) indicates nutrient needs are not being met for this food group. In this and similar scenarios, the text can begin with the phrase, “Your score indicates that you are currently not meeting your nutrient needs supplied by the dairy group. It is recommended that you increase your intake of low fat dairy foods to 3 servings per day.”

Any score higher than 0 for question 2 indicates intake of high fat dairy foods. In such scenarios, the text can also include the phrase, “Your score also indicates that you may be choosing dairy foods that are high in saturated fat and cholesterol. Choose low fat varieties within this food group.”

### Fruit

For questions 3 and 4, a combined score of 4.5 or more (≧4.5 servings per day) indicates nutrient needs are met for this food group. In this and similar scenarios, the text can begin with the phrase, “Congratulations, your score indicates that you are currently meeting your nutrient needs supplied by the fruit group. More matters when it comes to fruit, so continue to choose fruit often.” A combined score of less than 4.5 (<4.5 servings per day) indicates nutrient needs are not being met for this food group.

In this and similar scenarios, the text can begin with the phrase, “Your score indicates that you are currently not meeting your nutrient needs supplied by the fruit group. It is recommended that you increase your intake of a variety of whole fruit to receive the maximum benefit from this food group.”

Any score higher than 1 (>1 serving per day) for question 4 indicates intake of juice over whole fruit. In this and similar scenarios, the text can include the phrase, “Your score also indicates that you may be choosing juice in place of whole fruit. Choose a variety of whole fruit to receive the maximum benefit from this food group.”

### Vegetables

For questions 5 and 6, a combined score of 4.5 or more (≧4.5 servings per day) indicates nutrient needs are met for this food group. In this and similar scenarios, the text can begin with the phrase, “Congratulations, your score indicates that you are currently meeting your nutrient needs supplied by the vegetable group. More matters when it comes to vegetables, so continue to choose vegetables often.” A combined score of less than 4.5 (<4.5 servings per day) indicates nutrient needs are not being met for this food group. In this and similar scenarios, the text can begin with the phrase, “Your score indicates that you are currently not meeting your nutrient needs supplied by the vegetable group. It is recommended that you increase your intake of a variety of vegetables to receive the maximum benefit from this food group.”

Any score of 1 or more (≧1 serving per day) for question 6 indicates intake of starchy vegetables over green and orange vegetables. In this and similar scenarios, the text can include the phrase, “Your score also indicates that you may be choosing starchy vegetables in place of green and orange vegetables. Choose a variety of vegetables daily to receive the maximum benefit from this food group.”

### Grains

For questions 7 and 8, a combined score of 6 to 8 (≧6≦8 servings per day) indicates nutrient needs are met for this food group. In this and similar scenarios, the text can begin with the phrase, “Congratulations, your score indicates that you are currently meeting your nutrient needs supplied by the grain group.” A combined score of greater than 8 (>8 servings per day) indicates that nutrient needs are being exceeded for this food group. In this and similar scenarios, the text can begin with the phrase, “Your score indicates that you are currently exceeding your nutrient needs supplied by the grain group. It is recommended that you maintain an intake of 6-8 servings per day.” A combined score of less than 6 (<6 servings per day) indicates nutrient needs are not being met for this food group. In this and similar scenarios, the text can begin with the phrase, “Your score indicates that you may not be meeting your nutrient needs supplied by the grain group. It is recommended that you increase your intake of a whole grains to 6-8 servings per day.”

Any score of 3 or more (≧3 serving per day) for question 8 indicates intake of refined cereals and grains. In this and similar scenarios, the text can include the phrase, “Your score also indicates that you may be choosing refined cereals and grains over whole grains. Half of the grains you consume should come from the whole grain category to receive the maximum benefit from this food group.”

### Meat and Beans

For questions 9, 10, 11, 12, 13, a combined score of 2 or less (2 3-oz servings per day or less) indicates nutrient needs are met for this food group. In this and similar scenarios, the text can begin with the phrase, “Congratulations, your score indicates that you are currently meeting your nutrient needs supplied by the meat and beans group.”

A combined score of greater than 2 (>2 servings per day) indicates that nutrient needs are being exceeded for this food group. In this and similar scenarios, the text can begin with the phrase, “Your score indicates that you are currently exceeding your nutrient needs supplied by the meat and beans group. It is recommended that you maintain an intake of 2 3-oz servings or less.” A combined score of less than 1 (<1 servings per day) indicates nutrient needs are not being met for this food group. In this and similar scenarios, the text can begin with the phrase, “Your score indicates that you may not be meeting your nutrient needs supplied by the meat and beans group. It is recommended that you increase your intake of meat and beans to receive the maximum benefit from this food group.”

Any score of less than 0.5 (<2-4 servings per week) on questions 10 indicates that benefit is not received from consumption of fish. In this and similar scenarios, the text can include the phrase, “Your score also indicates that you may not be receiving the health benefits of fish and seafood consumption. Consume at least 2 servings of fish or seafood per week.” Any score of greater than 0.75 (>5-6 serving per week) on question 10 indicates that a warning may be necessary. In this and similar scenarios, the text can include the phrase, “Consuming fish and seafood is an important part of a healthy diet. Be sure to limit your intake of predatory fish to 12 ounces per week.” Any score greater than zero (>1 serving per week) for question 11 indicates the consumption of high fat, high sodium deli meats. In this and similar scenarios, the text can include the phrase, “Your score also indicates that you may be consuming protein foods that are high in saturated fat, cholesterol and sodium. Decrease your consumption of deli meats and choose low fat varieties within this food group.” Any score greater than 0.25 (>2-4 servings per week) for question 12 indicates a higher than recommended consumption of eggs. In this and similar scenarios, the text can include the phrase, “your score also indicates a higher than recommended consumption of eggs. Limit your consumption to between 2-4 eggs per week.” Any score of less than 0.25 (<5-6 servings per week) for question 13 indicates that a benefit is not received from the consumption of beans. In this and similar scenarios, the text can include the phrase, “Your score also indicates that you may not be choosing beans as a source of protein. To receive the maximum health benefit from this food group consume beans 5-6 times per week.”

### Nuts/Fat/Oil

For questions 14, 15 and 16, a combined score of 2 (2 servings per day) indicates nutrient needs are met for this food group. In this and similar scenarios, the text can begin with the phrase, “Congratulations, your score indicates that you are currently meeting your nutrient needs supplied by healthy varieties of fat and oil.” A combined score of greater than 2 (>2 servings per day) indicates that nutrient needs are being exceeded for this food group. In this and similar scenarios, the text can begin with the phrase, “Your score indicates that you are currently exceeding your nutrient needs supplied by healthy varieties of fat and oil.” These oils and fats although healthy are a source of concentrated calories. It is recommended that you maintain and intake of 2 servings per day. A combined score of less than 2 (<2 servings per day) indicates nutrient needs are not being met for this food group. In this and similar scenarios, the text can begin with the phrase, “your score indicates that you are currently not receiving a benefit from the consumption of healthy fats and oils. It is recommended that you Increase your intake of healthy fats and oils to 2 servings per day.”

Any score less than 0.75 (5-6 per week) for question 14 indicates that a benefit is not received from the consumption of nuts and seeds. In this and similar scenarios, the text can include the phrase, “Your score also indicates that you may not be receiving a health benefit from the consumption of nuts and seeds. Consume small portions of unsalted nuts and seeds 5-6 times per week.”

For dairy, grains, meat and beans, fats and oils, any questionnaire responses where the numbers of servings exceed the recommended and large portion sizes are checked should add an additional caution to the patient nutrition report. In this and similar scenarios, the text can include the phrase, “Proper portion sizes are essential to maintaining a healthy body weight and nutrient intake. Follow the recommended portion sizes outlined in your nutrition report.”

A daily food log can also be provided to aid the user in tracking their nutritional and caloric intake, which information can be incorporated into various of the health assessment algorithms and analyses, including disease risk and weight goals.

One of skill in the art will appreciate that the above listings and descriptions of various models and algorithms is merely illustrative of the type of algorithms that may be utilized in conjunction with the present invention to provide the desired analysis and outcome. As such models are improved or even replaced with different models over time, to the extent such models can be reduced to an executable algorithm, such models are anticipated for use in conjunction with the system and method of the present invention. As such, the present invention is by no means limited to the specific algorithms provided herein. Such models and algorithms are merely provided to demonstrate actual algorithms that may be implemented together with the system and method of the present invention.

### Weight Solution Tool

Additionally, the illustrative embodiment in accordance with the present invention can include a weight solution tool. Once users have been given nutritional information, the weight solution tool can further supplement users' needs by providing them with estimates for and target values of the number of calories necessary to consume per day to maintain/lose/gain weight in order to reach a safe goal weight in a safe amount of time. This is done by calculating ideal body weight, basal metabolic needs, and weight goal. The tool can be applied to data entered by a user or pre-populated data from an HRA.

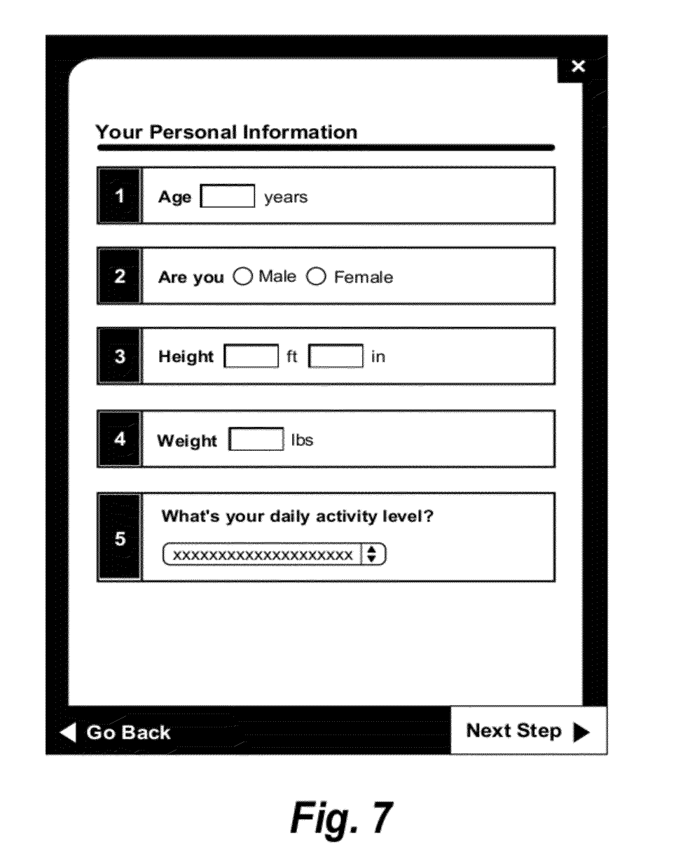

A sample user data input screen is shown in FIG. 7. Additional questions can be presented to the user for necessary data collection. These additional questions can include questions regarding daily activity level. Possible answer choices can include:

Little or no exercise

Light exercise/sports 1-3 days per week

Moderate exercise/sports 3-5 days per week

Hard exercise/sports 6-7 days a week

Very hard exercise/sports & physical job or 2× training

Next, an ideal body weight (IBW) value is determined using, e.g., the Hamwi method, as would be understood by those of ordinary skill in the art. IBW is calculated within a range of +/−10%. For men, 106 lbs is given for the first 5 feet, and 6 additional lbs is added for every inch over 5 feet. For women, 100 lbs is given for the first 5 feet, and 5 additional lbs is added for every inch over 5 feet. An additional 10% is added for patients having a large frame and 10% is deducted for patients having a small frame. For example, if a 5′4″ woman having medium frame is given a IBW of 120 lbs.

The formula described above can also provide a range from small frame to large frame using the +/−10% IBW range. For example, a 5′4″ woman should be within the range of 108-132 lbs. In the illustrative embodiment, the IBW output is over the range of +/−10%.

### Calculate Energy Needs (Basal Energy Expenditure BEE)

The predicted amount of calories burned per day is also utilized for the weight solution tool. The Harris-Benedict formula is used to determine calories burned per day for a patient. For men, the Basal Energy Expenditure (BEE) is given by:

BEE=66.5+(13.75×weight in kg)+(5.003×height in cm)−(6.775×age)

For women, the Basal Energy Expenditure is given by:

BEE=655.1+(9.563×weight in kg)+(1.850×height in cm)−(4.676×age)

Once BEE is calculated, the number of calories expended per day is calculated.

This depends on a variety of behavioral habits, such as amount exercise, etc. In the illustrative embodiment, the equations below can be used to calculate the number of calories made expended for various types of patients.

For sedentary patients (i.e., little or no exercise)=BEE×1.2.
For lightly active patients (i.e., light exercise/sports 1-3 days/week) day=BEE×1.375
For moderately active patients (moderate exercise/sports 3-5 days/week)=BEE×1.55
For very active patients (hard exercise/sports 6-7 days a week)=BEE×1.725
For extra active patients (very hard exercise/sports & physical job or 2× training)=BEE×1.9

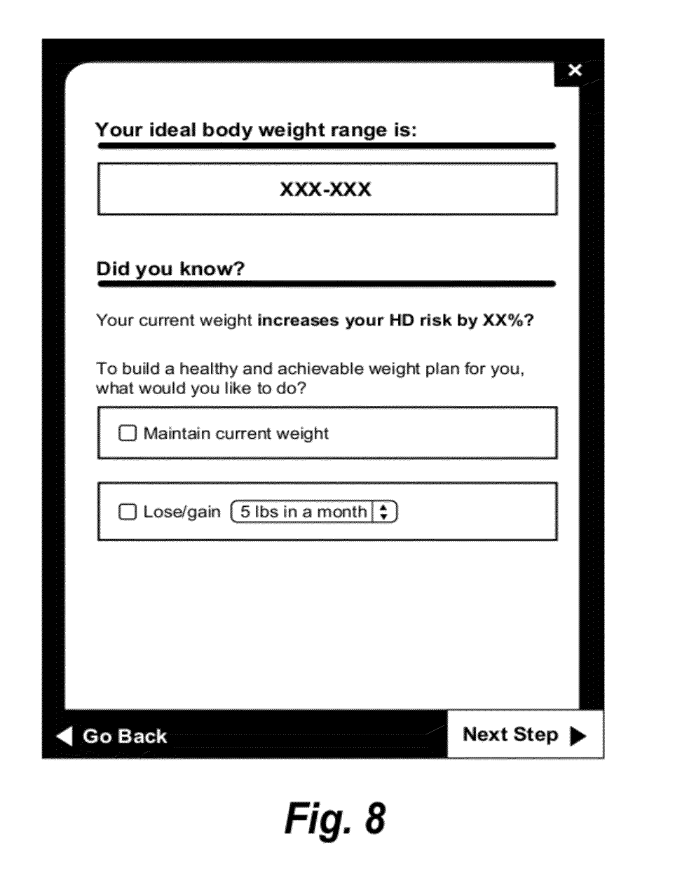

The illustrative embodiment of the present invention also requests a target amount of weight loss/gain from the patient, which can be entered by the user into a page such as the one shown in FIG. 8. Some possible target weight loss/gain options:

2 pounds in one month

5 pounds in one month

8 pounds in one month

10 pounds in two months

12 pounds in two months

15 pounds in two months

In the illustrative embodiment, the corresponding change in calories per day for these goals are assumed to be:

2 pounds in one month=250 calories

5 pounds in one month=575 calories

8 pounds in one month=920 calories

10 pounds in two months=575 calories

12 pounds in two months=700 calories

15 pounds in two months=875 calories

The screen shot shown in FIG. 8 can also include the potential for risk of developing particular diseases related to nutrition, diet, and weight, among other possible adverse health conditions. To determine this risk, the Body Mass Index (BMI) can be calculated since it can be correlated with heart disease risk. In the illustrative embodiment, the formula used to calculate BMI is:

BMI=703*(weight/height̂2)

Here, weight is current weight in pounds and height is current height in inches.

Depending on whether the user is a male or female, the value of IBW, and the value of BMI, the page shown in FIG. 8 will include various text strings and a list of web features/options that are available to the user on the user account.

For men and women within their IBW, if their BMI is less than 25, the page will display “Congratulations. You are within your ideal body weight. To continue building a healthy and achievable weight plan for you, what would you like to do?”

For men and women who are below their IBW and also have a BMI lower than 25, the page will display the text “Did you know? You are below your ideal body weight range and your current weight could lead to serious health implications, including osteoporosis. To continue building a healthy and achievable weight plan for you, what would you like to do?”

For men and women who are above their IBW and also have a BMI lower than 25, the page will display the text “Did you know? You are above your ideal body weight range. To continue building a healthy and achievable weight plan for you, what would you like to do?”

For men who are above their IBW and have a BMI between 25 and 29.9, the page will display “Did you know? You are above your ideal body weight range. Your current weight increases your risk for heart disease by up to 24%. To reduce your risk of heart disease your goal weight is XXX pounds. To continue building a healthy and achievable weight plan for you, what would you like to do?”

For men who are above their IBW and have a BMI less than or equal to 30, the page will read “Did you know? You are above your ideal body weight range. Your current weight increases your risk for heart disease by up to 38%. To reduce your risk of heart disease your goal weight is XXX pounds. To continue building a healthy and achievable weight plan for you, what would you like to do?”

For women who are above their IBW and who have a BMI of 25-29.9, the page will read “Did you know? You are above your ideal body weight range. Your current weight increases your risk for heart disease by up to 13%. To reduce your risk of heart disease your goal weight is XXX pounds. To continue building a healthy and achievable weight plan for you, what would you like to do?”

For women who are above their IBW and have a BMI less than or equal to 30, the page will display “Did you know? You are above your ideal body weight range. Your current weight increases your risk for heart disease by up to 38%. To reduce your risk of heart disease your goal weight is XXX pounds. To continue building a healthy and achievable weight plan for you, what would you like to do?”

For men who are within their IBW and have a BMI of between 25 and 29.9, the page will read “Did you know? You are within your ideal body weight range. Your current weight however, increases your risk for heart disease by up to 24%. To reduce your risk of heart disease your goal weight is XXX pounds. To continue building a healthy and achievable weight plan for you, what would you like to do?”

For men who are within their IBW and have a BMI of less than or equal to 30, the page will display “Did you know? You are within your ideal body weight range. Your current weight however, increases your risk for heart disease by up to 38%. To reduce your risk of heart disease your goal weight is XXX pounds. To continue building a healthy and achievable weight plan for you, what would you like to do?”

For women who are within their IBW and have a BMI of from 25 to 29.9, the page will read “Did you know? You are within your ideal body weight range. Your current weight however, increases your risk for heart disease by up to 13%. To reduce your risk of heart disease your goal weight is XXX pounds. To continue building a healthy and achievable weight plan for you, what would you like to do?”

For women who are within their IBW and have a BMI of less than or equal to 30, the age will read “Did you know? You are within your ideal body weight range. Your current weight however, increases your risk for heart disease by up to 38%. To reduce your risk of heart disease your goal weight is XXX pounds. To continue building a healthy and achievable weight plan for you, what would you like to do?”

The page can include a list of web features/options available to the user based on their personalized data and information. These options include maintaining wait, losing weight, and gaining weight. For the illustrative embodiment, if “maintain” and “lose” are both options that are available to the user, then the page will list the “lose” option (along with a dropdown box showing loss goals) above the “maintain” option. If “maintain” and “gain” are both options available to the user, then the page will display “gain” (along with dropdown box showing gain goals) on the top of the list above the “maintain” option. If “loss,” “maintain,” and “gain” are all determined to be options available to the user, the page will display “maintain” at the top of this list and will display “lose” and “gain” second in the list. If there is only one option available to the user it will be the only option listed on the page.

Next, for a user who selects either “loss” or “gain,” the user also selects his or her target amount of weight loss or gain. Possible goal weight loss/gain options are:

2 pounds in one month

5 pounds in one month

8 pounds in one month

10 pounds in two months

12 pounds in two months

15 pounds in two months

These goals correspond to the following changes in calories per day:

2 pounds in one month=250 calories

5 pounds in one month=575 calories

8 pounds in one month=920 calories

10 pounds in two months=575 calories

12 pounds in two months=700 calories

15 pounds in two months=875 calories

If the user chooses to lose weight, then only the weight loss goals that are presented to the user are those goals that bring the user within the lowest bound of their IBW range. Specifically:

Goal weight(for weight loss)=current weight−weight loss

Furthermore:

Goal weight(for weight gain)=current weight+weight gain

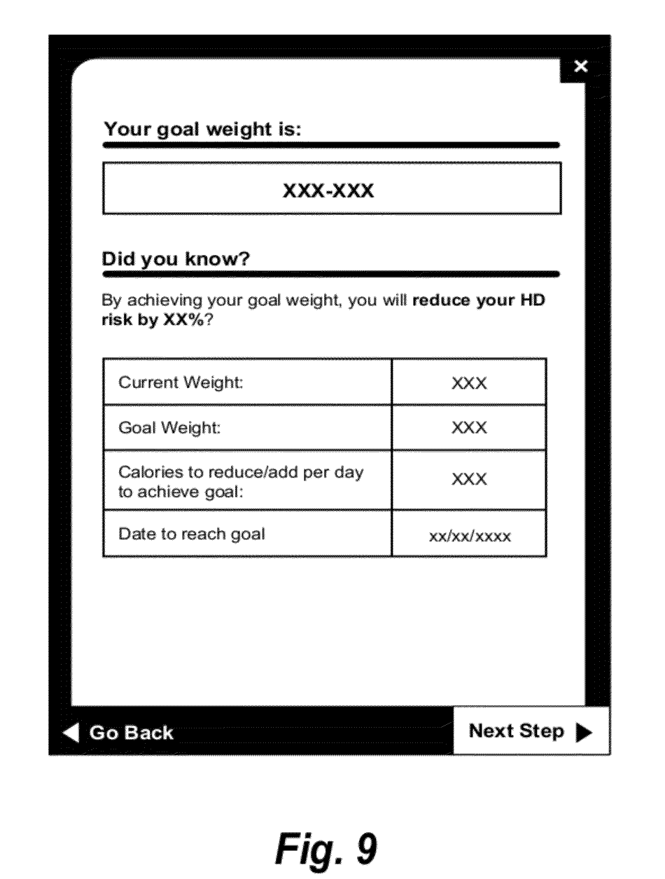

Information about the weight and calorie loss/gain requirements will be presented to the user in a weight goal summary on a page such as the one shown in FIG. 9. This page will also display information relating to heart disease risk, depending on the user's particular current and target BMI values. The various associated risks are given below:

### For Men

If current BMI=25-29.9 AND if goal weight leads to a BMI<25, the page will show: “By achieving your goal weight, you will reduce your heart disease risk by up to 24%.”
If current BMI<=30 AND if goal weight leads to a BMI=25-29.9, the page will show: “By achieving your goal weight, you will reduce your heart disease risk by up to 14%.”
If current BMI<=30 AND if goal weight leads to a BMI<29.9, the page will show: “By achieving your goal weight, you will reduce your heart disease risk by up to 38%.”
If current BMI=goal BMI=25-29.9, the page will show: “Your goal weight keeps you at an increased heart disease risk of up to 24%.”
If current BMI=goal BMI<=30, the page will show: “Your goal weight keeps you at an increased heart disease risk of up to 38%.”
If current BMI=25-29.9 AND if goal weight leads to a BMI=25-29.9, the page will show: “Your goal weight however, increases your risk for heart disease by up to 24%.”
If current BMI<=30 AND if goal weight leads to a BMI<29.9, the page will show: “Your goal weight however, increases your risk for heart disease by up to 38%.”

### For Women

If current BMI=25-29.9 AND if goal weight leads to a BMI<25, the page will show: “By achieving your goal weight, you will reduce your heart disease risk by up to 13%.”
If current BMI<=30 AND if goal weight leads to a BMI=25-29.9, the page will show: “By achieving your goal weight, you will reduce your heart disease risk by up to 25%.”
If current BMI<=30 AND if goal weight leads to a BMI<29.9, the page will show: “By achieving your goal weight, you will reduce your heart disease risk by up to 38%.”
If current BMI=goal BMI=25-29.9, the page will show: “Your goal weight keeps you at an increased heart disease risk of up to 13%.”
If current BMI=goal BMI<=30, the page will show: “Your goal weight keeps you at an increased heart disease risk of up to 38%.”
If current BMI=25-29.9 AND if goal weight leads to a BMI<25, the page will show: “By achieving your goal weight, you will reduce your heart disease risk by up to 13%.”
If current BMI<=30 AND if goal weight leads to a BMI<29.9, the page will show: “By achieving your goal weight, you will reduce your heart disease risk by up to 38%.”

In the illustrative embodiment, the dates given to reach the goal will equal the current date plus either 30 or 60 days. Other target weight loss/gain/maintaining periods are possible. There can be several limiting factors on risk factors discussed above. Specifically, the calorie loss per day must be greater than or equal to 1,500 for the heart disease risk values to hold true. Additionally, the goal weight must be greater than or equal to the minimum IBW.

Various pages, such as the example page shown in FIG. 9, can depict weight loss/gain goals and can include pertinent information for the user, such as current) weight, goal weight, calories needed per day to reach goal, and the specific date the user will reach goal. Pages that depict weight maintaining goals can include information such as current weight, goal weight, and the number of calories needed per day to maintain weight.

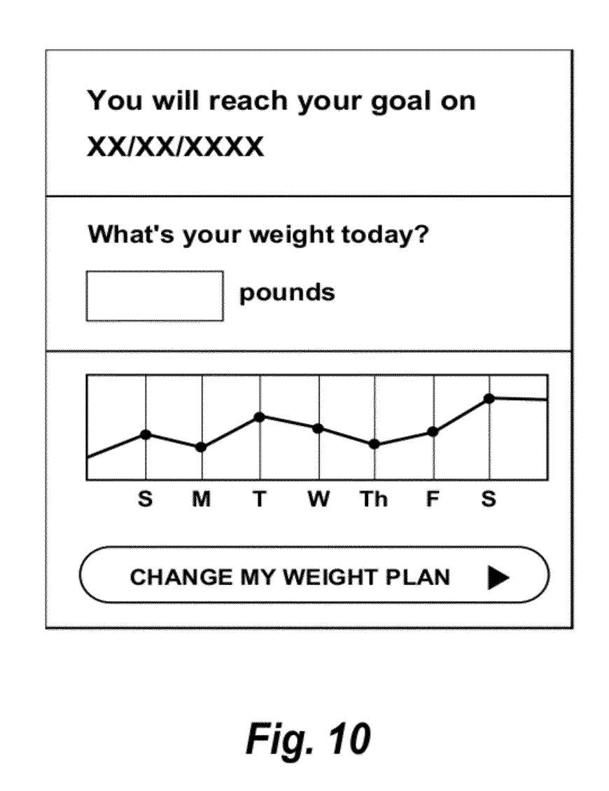

Further information can be included in the page shown in FIG. 10, which includes the target date for reaching the user's goal to lose, gain, or maintain weight. Additionally, this page can include an entry field for the user to regularly input his or her weight in order to track the user's progress in a chart or graph over the specified time period.

A fitness tool can further be provided, providing assessment, summary, goal setting tools, recommended exercise for reducing disease risks and achieving goals, and tracking progress over time.

### Meal Planner Tool

The illustrative embodiment of the present invention can additionally include a meal planner tool. This tool can assist users with specific meals necessary to achieve particular health and weight goals. These goals may be aligned with the goals developed by the user using the Weight Solution Tool, or they may be independent goals.

In accordance with the illustrative embodiment of the present invention, a new user can view the nutrition homepage, click a “Create a menu” button, view the “customize diet” page, and indicate in the page whether or not they have any known health risks by checking appropriate boxes. The user can then select preferences based on food groups, ingredients, healthiness, etc. If no preferences selected, the default is set to “General Healthy Diet.” If a weight goal is selected, the user may input data already stored in the weight solution tool. If the user has selected a weight goal but has not entered the appropriate data into the weight solution tool, the user is prompted to complete the necessary information fields in the weight solution tool.

The user then can click a “next” button and can view an automatically generated menu for the day. Next, the user can choose a “new meal” options. The user can then add items from the meal (i.e., ingredients) to a shopping list, which can be viewed by clicking an appropriate button. The list can provide the user with the ability to track the various food groups included in the meals, and the user can save and print daily menus.

The web features can also enable the user to plan, save, and print menus for the future. When a user clicks on a particular date in the calendar, a blank menu appears with a pop-up window that includes the message: “Do you want a menu suggested for you?” If the user selects “yes,” then a template is populated with meals that match the user's selected customization/preferences. If the user clicks “no,” then the template remains blank and the user can choose each meal individually from its corresponding dropdown menu. Additionally, the web features allow the user to navigate back to the customization/preferences page, nutrition homepage, or food tracker page at any time.

A nutritionist, which can be, for example, an employee working with the site or an automated feature included in the site, can generate meals that will be used to populate the site. A database of meals will be maintained having associated data that informs the user of the degree to which a particular meal fits the health needs/weight goals/personal preferences of the user. All meals will be classified according to food groups included, as well as other categories mentioned herein that are suitable classification categories.

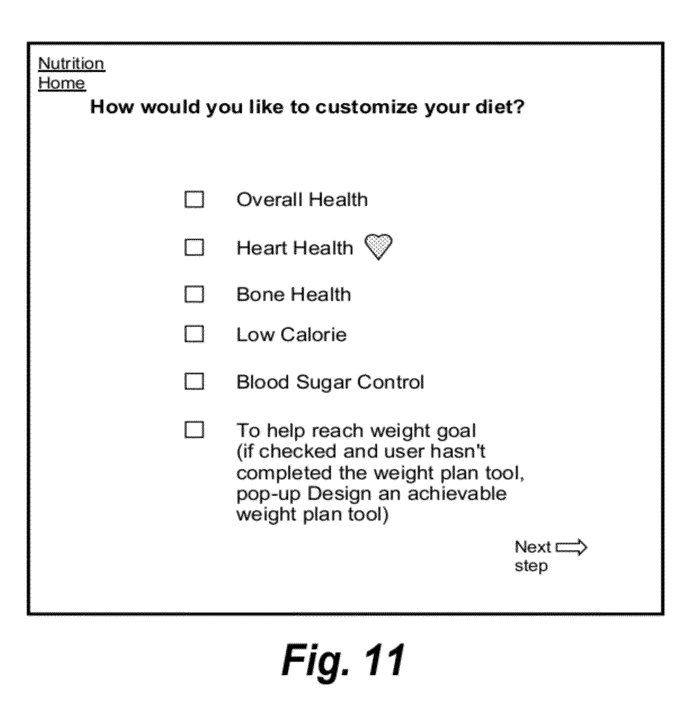

In the illustrative embodiment, as shown in FIG. 11, a diet customization page can allow the user to enter preferences based on various health needs and goals. These can include to promote overall health, heart health, bone health, low calorie intake, blood sugar control, and desired weight goal. If the user does not select an option, then the default is set to a “General Health” template for a 2,000 calorie per day diet.

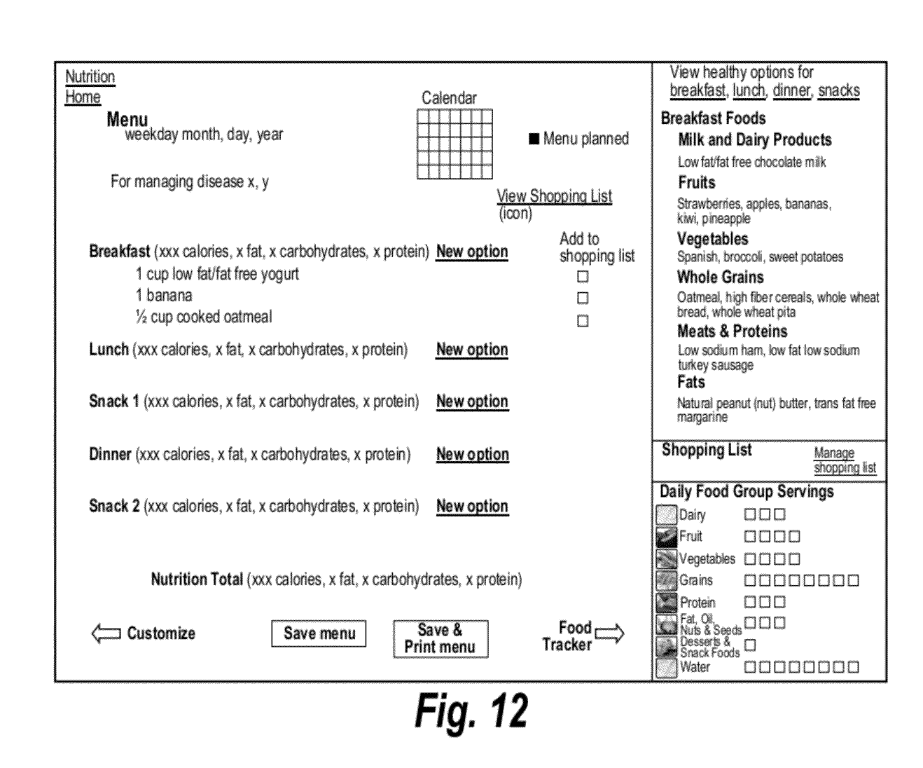

Once the user clicks the “next” button, he is taken to a “Today's Menu” page, as shown in FIG. 12. This page allows the user to plan menus and meals for any future date accessible by a calendar application. The “Today's Menu” page presents the user with a template based on the preferences selected on the customization page of FIG. 11.

All daily menus shown in the template will have the format: Breakfast, Lunch, Snack, Dinner, Snack. Templates will be generated by a nutritionist for 1,500 cal/day diets, 1,800 cal/day diets, 2,000 cal/day diets, 2,200 cal/day diets, 2,500 cal/day diets, 2,800 cal/day diets, and 3,000 cal/day diets. Additionally, the various types of meals within the templates will be classifiable according to a wide range of categories.

The “Today's Menu” page enables users to choose a new meal option. Meals are treated as even exchange for caloric and nutrient content, which can be made accessible to the user on the page. The user can further select to display the ingredients contained within the meal on a customizable shopping list. Days shown on the calendar can be color coded to indicate whether or not a meal has been planned or tracked for a particular day.

The “Today's Menu” page can also display educational content on the right hand side of the page for healthy food substitutions. The content can be dynamic and can correspond to the particular meal the user selects. The content can change when the user selects a breakfast, lunch, dinner, snack link and/or when the user selects a new meal option from the dropdown. For example, if the user selects a new option for lunch, healthy lunch options can be displayed along the right hand side. The content can be provided by the nutritionist and can be flagged and categorized according to type of meal, food groups, and diseases for which it can help reduce risk of development by the user or patient.

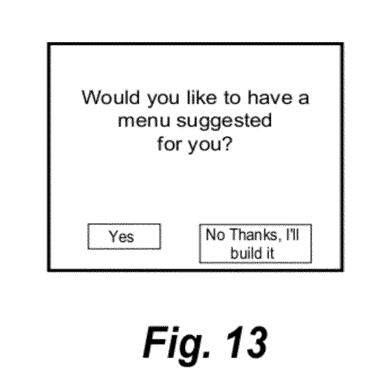

Additionally, the user can select a day from the calendar to view whether items or menus were created or tracked for past dates. For example, if the user selects a past date and a menu was created but not tracked, the menu that was created will be displayed. If the user selects a date that is in the past for which a menu was both created and tracked, the tracked menu will be displayed. If the user selects a date in the past and no menu was created or tracked, a message will be presented to the user in a pop-up window, stating “No meal was created or tracked for this day.” If the user selects a date in the future, the user will be given an option to plan a menu for that day, as shown in the pop-up screen in FIG. 13.

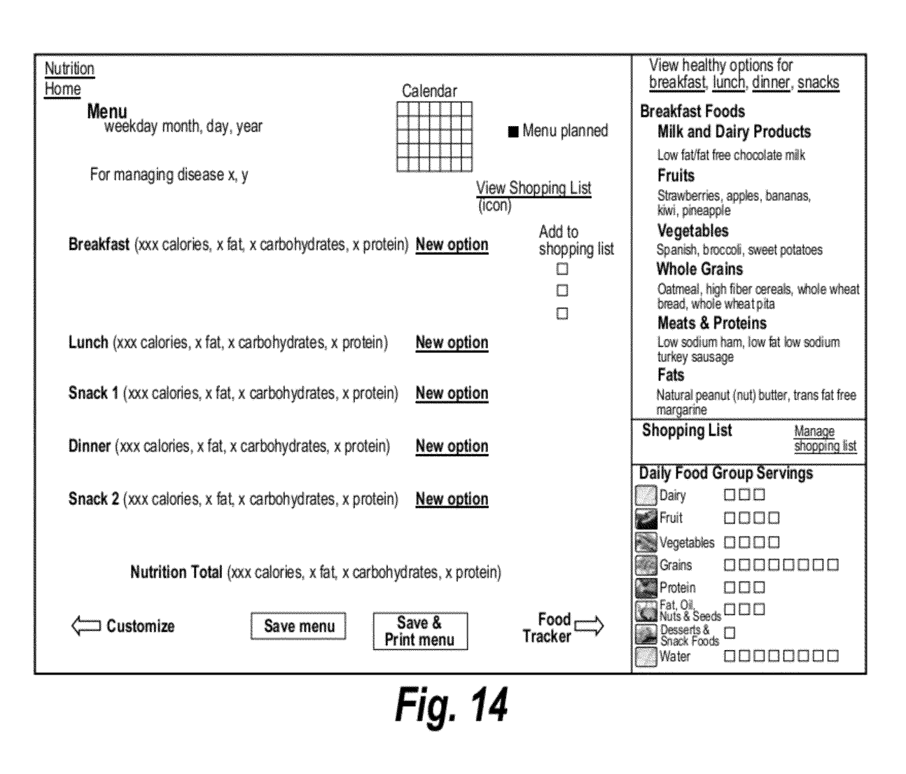

To plan a menu, for a date in the future, a user first selects a day in the future from the calendar. If the user prefers to build a menu from a list of suggested meals, the user can click the “Yes” button shown in FIG. 13. If the user prefers to build a menu without such suggestions, the user can click the “No” button. The user can then browse meals from the database provided by the nutritionist and select desirable meals that match the user's customization criteria/preferences from dropdown menus accessible from the menu building page shown in FIG. 14. Otherwise, all other page functionality of the page shown in FIG. 14 is the same as FIG. 12. If the user clicks the “Food tracker” button, the user will be redirected to a “Today's Food Tracker” page.

In addition to the features and tools described herein, users can have the opportunity to confidentially participate in an online health care community. This participation can be based not only on actual disease but also on unique phenotype information users provide. For example, a patient with an above normal eating habits can participate in such a community to learn ways to prevent overeating, or can gain access to available resources in a particular geographic community, etc. Furthermore, participation in a community could be based on genotype information and/or genotype/phenotype correlations.

The one or more databases store user and patient information, including user logon/ID information (e.g., e-mail address) and medical information including the answers to questionnaires and the calculated nutrition assessments. The answers and risks can be classified several ways within database (e.g., according to the medical condition, medications, medical conditions within specific demographics; such as age, gender, race, level of education, etc., and geographic location). Each assessment can be linked to corresponding medical information, advertisements, etc.

The content displayed to the users can be categorized by medical condition and a tiered advertisement payment plan. Other methods of categorization are also possible.

In accordance with some embodiments of the present invention, there can be two databases, including one database containing patient medical questionnaire information and calculated assessment data, and the other database containing content to be displayed on the website including medical information and ads, with the content being linked to particular patients and/or medical conditions. Alternatively, a single central database can be used containing both the user information as well as the content.

In addition to the collection of patient information, and the automated ability to execute one or more algorithms for assessing patient health conditions, the present invention further executes one or more automated processes to assess results of each individual health assessment algorithm and to determine an overall nutrient and health scores, as well as to determine recommendations and offer detailed plans for achieving particular patient goals based on specific health needs.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above are preferably implemented in software, and accordingly one of the preferred implementations of the invention is as a set of instructions (program code) in a code module resident in the random access memory of a computer or computing device 102 as described herein. Until required by the computer, the set of instructions may be stored in another computer memory, e.g., in a hard disk drive, or in a removable memory such as an optical disk (for eventual use in a CD or DVD ROM) or floppy disk (for eventual use in a floppy disk drive), a removable storage device (e.g., external hard drive, memory card, or flash drive), or downloaded via the Internet or some other computer network. In addition, although the various methods described are conveniently implemented in a computer selectively activated or reconfigured by software, one of ordinary skill in the art would also recognize that such methods may be carried out in hardware, in firmware, or in more specialized apparatus constructed to perform the specified method steps.

For example, the questions, answer choices, surveys, data collection mechanisms, and other features described herein can be presented in one or more electronic displays on at least one output device included in a computer implemented system that further includes one or more non-transitory machine readable storage devices, as would be appreciated by one of skill in the art. For instance, certain embodiments of the present invention provide a server device that includes one or more non-transitory machine readable storage media containing instructions stored thereon that, when executed by a processor, cause one or more interactive displays to be presented to one or more users across one or more communication networks (e.g., the Internet). Users can be enabled to access the one or more interactive displays on any computing device, including, as non-limiting examples, a “laptop,” a “desktop,” a “hand-held device,” a “mobile device,” a “tablet computer,” a “portable transceiver,” a “set-top box” (e.g. for internet TV), a “smart phone device,” and any other computing device.

For instance, as a further embodiment of an exemplary system according to the present invention, users can be enabled to access the features, tools, pages, and displays described herein on a portable user device, such as a smart phone device, a mobile device, a tablet computer, a hand-held device, etc. The portable user device can include one or more location detection components, such as a global positioning system (GPS). The exemplary system can utilize the location detection component to provide users with the ability to the ability to associate particular physical or geographic locations with particular tags, labels, categories, and the like. For example, in one embodiment, users provided with one or more displays enabling the associating of particular user-selected locations with any one or more of the following virtual tags: a “home” tag, a “grocery store” tag, a “restaurant” tag, a “gym” tag, a “work” tag, and the like. One of skill in the art will appreciate that these tags are exemplary and do not limit embodiments of the present invention. Rather, a wide range of other tags are possible. Furthermore, the system can include or interface with one or more databases containing a plurality of pre-existing tags, e.g., a tags database containing a plurality of locations tagged as restaurants.

In such exemplary systems according to certain illustrative embodiments of the present invention, the system can prompt users with one or more of the displays described herein in response to receiving a signal from a user device indicating that the user device is geographically located within an area designated according to one of the tags described herein. For instance, if a user device sends a signal across a communications network to the system indicating that the user device is located within a location tagged as “gym” (or in close proximity to the location tagged as “gym”), the system can prompt the user device with one or more exercise routines by displaying the one or more exercise routines on the monitor of the user device. Similarly, if a user device sends a signal to the system indicating that the user device is located within allocation tagged as “grocery store” (or in close proximity to the location tagged as “grocery store”), the system can prompt the user device with one or more recipe lists, grocery lists, ingredients lists, menu lists, meal lists, and the like, e.g., by display such lists, etc. on the monitor of the user device. In this manner, the system can utilize location awareness to provide information and content to users in a convenient, manageable, and encouraging way.

In general, for such embodiments of the system involving location detection components, signals sent by a user device to the system containing information pertaining to the location of the user device can be initiated manually (e.g., by the user operating the user device), automatically (e.g., by the user device upon sensing its location within a tagged geographic area), or some combination thereof.

As yet a further embodiment, location detection components can be utilized to enable users to access lists of recommended restaurants (and the like). For instance, the system further can include or interface with one or more databases of restaurants and their respective geographic locations. The interactive displays described herein further can include one or more displays enabling users to request “nearby recommended restaurants.” Upon receiving the request, the system can (a) receive the geographic location of the user device (e.g., by causing the user device to transmit its geographic location), (b) use the received geographic location to generate a query for searching one or more databases, (c) execute the query against one or more databases to generate a plurality of recommendations comprising database entries that satisfy the query parameters or requirements, and (d) send the generated recommendations to the user device (e.g., as a display presented on a monitor or other output device of the user device). Similarly, this method is not limited to nearby recommended restaurants. Rather, this method can be used by the system to generate and cause the display of a wide range of recommended information, e.g., nearby recommended shopping malls, nearby recommended grocery stores, nearby recommended gyms, nearby recommended parks, nearby recommended running courses, nearby recommended bike routes, and the like.

Furthermore, in general, the displays of information described herein can be presented in conjunction with a plurality of additional information pertaining thereto. For instance, the system can communicate with one or more external websites, databases, and the like to additionally provide any one or more of the following: general or specific educational content on diseases and/or behaviors (e.g., for which a user is at risk); news content associated with diseases and/or behaviors (e.g., for which a user is at risk); recipes; links to relevant websites, online resources, and social media focused on building communities around various topics and conditions; and other information. For example, social media websites can be utilized in order to create virtual communities of individuals based on common recommendations, assessments, predictions, and the like as provided by the systems described herein in accordance with embodiments of the present invention.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention.

What is claimed is:

1. A computer implemented method, comprising:
receiving, from one or more input devices, patient data comprising one or more of phenotype data specific to a patient, biometric data specific to the patient, nutritional health data specific to the patient, medical claims data specific to the patient, and organizational data specific to an organization to which the patient belongs;
generating, using one or more processors, one or more predictive models based on the patient data, using one or more algorithms executing on at least one processor of a computing apparatus, the one or more predictive models determining and indicating potential for development by the patient of disease and adverse health conditions, or providing users with weight management guidelines and meal planning, or both; and
outputting, onto one or more output devices, the potential for development by the patient of disease and adverse health conditions, the weight management guidelines and meal planning, or both.

2. The computer implemented method of claim 1, wherein the potential for development by the patient of disease and adverse health conditions, the weight management guidelines and meal planning, or both further are caused to be presented on one or more electronic displays of information.

3. The computer implemented method of claim 1, further comprising providing a weight solution tool.

4. The computer implemented method of claim 1, further comprising:
receiving, from one or more input devices, an ideal body weight for a user;
calculating, using one or more processors, a caloric expenditure value for the user that is based at least in part on the received patient data;
calculating, using one or more processors, a first body mass index for the user that is based at least in part on the caloric expenditure value; and
outputting, onto one or more output devices, a risk percentage change that is based at least in part on the first body mass index and the received ideal body weight.

5. The computer implemented method of claim 4, further comprising calculating, using one or more processors, a basal energy expenditure for the user, wherein the step of calculating a caloric expenditure value is based at least in part on the calculated basal energy expenditure.

6. The computer implemented method of claim 1, further comprising:
receiving, from one or more input devices, a plurality of user data pertaining to a weight goal;
generating, using one or more processors, one or more charts or graphs comprising the received user data pertaining to the weight goal; and
outputting, onto one or more output devices, the one or more generated charts or graphs;
wherein the one or more generated charts or graphs track progress of a user toward the weight goal.

7. The computer implemented method of claim 1, further comprising providing a nutritional health assessment tool.

8. The computer implemented method of claim 1, further comprising calculating, using one or more processors, any one or more of the following: a caloric intake score, a nutrient score, and a servings score.

9. The computer implemented method of claim 1, further comprising, for each of a plurality of different food groups, calculating a servings score that is based at least in part on the received patient data.

10. The computer implemented method of claim 1, further comprising providing a meal planner tool.

11. The computer implemented method of claim 1, further comprising:
receiving one or more user preferences comprising one or more health needs or health goals; and
outputting, onto one or more output devices, one or more menus presenting meal information;
wherein the meal information is customized according to the one or more health needs or health goals.

12. The computer implemented method of claim 11, further comprising enabling a user to modify one or more of the meal information.

13. The computer implemented method of claim 1, further comprising outputting, onto one or more output devices, a calendar organizing the one or more meal information according to date.

14. The computer implemented method of claim 1, further comprising:
receiving, from one or more input devices, a signal indicating that a user device is within a predetermined distance of a tagged location; and
sending information to the user device, the information being determined at least in part based on the weight management guidelines, the meal planning, or both, and the tagged location.

15. A computer implemented method, comprising:
receiving, from one or more input devices, patient data comprising one or more of phenotype data specific to a patient, biometric data specific to the patient, nutritional health data specific to the patient, medical claims data specific to the patient, and organizational data specific to an organization to which the patient belongs;
generating, using one or more processors, one or more predictive models based on the patient data, using one or more algorithms executing on at least one processor of a computing apparatus, the one or more predictive models determining user specific weight management guidelines, meal planning recommendations, or both; and
outputting, onto one or more output devices, the weight management guidelines, meal planning recommendations, or both, to the user.

16. The computer implemented method of claim 15, wherein the potential for development by the patient of disease and adverse health conditions, the weight management guidelines and meal planning, or both further are caused to be presented on one or more electronic displays of information.

17. The computer implemented method of claim 15, further comprising providing a weight solution tool.

18. The computer implemented method of claim 15, further comprising:
receiving, from one or more input devices, an ideal body weight for a user;
calculating, using one or more processors, a caloric expenditure value for the user that is based at least in part on the received patient data;
calculating, using one or more processors, a first body mass index for the user that is based at least in part on the caloric expenditure value; and
outputting, onto one or more output devices, a risk percentage change that is based at least in part on the first body mass index and the received ideal body weight.

19. The computer implemented method of claim 18, further comprising calculating, using one or more processors, a basal energy expenditure for the user, wherein the step of calculating a caloric expenditure value is based at least in part on the calculated basal energy expenditure.

20. The computer implemented method of claim 15, further comprising:
receiving, from one or more input devices, a plurality of user data pertaining to a weight goal;
generating, using one or more processors, one or more charts or graphs comprising the received user data pertaining to the weight goal; and
outputting, onto one or more output devices, the one or more generated charts or graphs;
wherein the one or more generated charts or graphs track progress of a user toward the weight goal.

21. The computer implemented method of claim 15, further comprising providing a nutritional health assessment tool.

22. The computer implemented method of claim 15, further comprising calculating, using one or more processors, any one or more of the following: a caloric intake score, a nutrient score, and a servings score.

23. The computer implemented method of claim 15, further comprising, for each of a plurality of different food groups, calculating a servings score that is based at least in part on the received patient data.

24. The computer implemented method of claim 15, further comprising providing a meal planner tool.

25. The computer implemented method of claim 15, further comprising:
receiving one or more user preferences comprising one or more health needs or health goals; and
outputting, onto one or more output devices, one or more menus presenting meal information;
wherein the meal information is customized according to the one or more health needs or health goals.

26. The computer implemented method of claim 25, further comprising enabling a user to modify one or more of the meal information.

27. The computer implemented method of claim 15, further comprising outputting, onto one or more output devices, a calendar organizing the one or more meal information according to date.

28. The computer implemented method of claim 15, further comprising:
receiving, from one or more input devices, a signal indicating that a user device is within a predetermined distance of a tagged location; and
sending information to the user device, the information being determined at least in part based on the weight management guidelines, the meal planning, or both, and the tagged location.

29. In a networked computer environment, a system, comprising:
a storage device storing patient data comprising one or more of phenotype data specific to a patient, biometric data specific to the patient, nutritional health data specific to the patient, medical claims data specific to the patient, and organizational data specific to an organization to which the patient belongs;
at least one processor provided with executable instructions for generating one or more predictive models, using one or more algorithms executing on the at least one processor, the one or more predictive models determining and indicating a potential for development by the patient of disease and adverse health conditions, or providing users with weight management guidelines and meal planning, or both; and
an output mechanism configured to output the potential for development by the patient of disease and adverse health conditions, the weight management guidelines and meal planning, or both.

30. In a networked computer environment, a system, comprising:
a storage device storing patient data comprising one or more of phenotype data specific to a patient, biometric data specific to the patient, nutritional health data specific to the patient, medical claims data specific to the patient, and organizational data specific to an organization to which the patient belongs;
generating one or more predictive models based on the patient data, using one or more algorithms executing on at least one processor of a computing apparatus, the one or more predictive models determining user specific weight management guidelines, meal planning recommendations, or both; and
an output mechanism configured to output the weight management guidelines, meal planning recommendations, or both, to the user.
